(19) United States
(12) Patent Application Publication
(10) Pub. No.: US 2020/0055762 A1
(43) Pub. Date: Feb. 20, 2020

(54) METHOD FOR CONVERSION OF WET BIOMASS TO ENERGY

(71) Applicant: BOARD OF REGENTS OF THE NEVADA SYSTEM OF HIGHER EDUCATION, ON BEHALF OF THE UNIVERSITY OF NEVADA, RE, Reno, NV (US)

(72) Inventor: Charles J. CORONELLA, Reno, NV (US)

(73) Assignee: BOARD OF REGENTS OF THE NEVADA SYSTEM OF HIGHER EDUCATION, ON BEHALF OF THE UNIVERSITY OF NEVADA, RE, Reno, NV (US)

(21) Appl. No.: 16/609,937

(22) PCT Filed: May 1, 2018
(86) PCT No.: PCT/US2018/030524

§ 371 Date: Oct. 31, 2019

Related U.S. Application Data
(60) Provisional application No. 62/492,842, filed on May 1, 2017.

(51) Int. Cl. C02F 11/10; C02F 11/08; B09B 3/00

(52) U.S. Cl. CPC C02F 11/10; C02F 2103/20; B09B 3/0083; C02F 11/08

(57) ABSTRACT

Disclosed herein is a method of converting waste, such as wet biomass, to a clean product and energy, including heat, and/or power. The disclosed method combines hydrothermal processing, also known as anaerobic hydrothermal carbonization, followed by wet air oxidation, adding sufficient oxygen to ensure rapid and complete destruction of organics.

### CROSS REFERENCE TO RELATED APPLICATION

This application claims the benefit of priority to U.S. Patent Application No. 62/492,842, filed on May 1, 2017, which is hereby incorporated by reference in its entirety.

### ACKNOWLEDGMENT OF GOVERNMENT SUPPORT

This invention was made with government support under grant numbers 11-1301726 awarded by the National Science Foundation and 2010-38502-21839 awarded by the USDA. The government has certain rights in the invention.

### FIELD

This disclosure relates to wet biomass, and in particular, to methods for conversion of wet biomass to energy, such as heat, and power.

### BACKGROUND

Many industries, such as dairies and feed lots, produce significant aqueous wastes which require substantial cleanup before being dumped to surface waters or even to municipal wastewater treatment operations. At the same time, these industries consume massive amounts of energy to produce heat, cooling, steam and electricity to be used throughout the company for various purposes. There exists a need for a process that solves these two problems (e.g., disposal of aqueous wastes and generation of energy) simultaneously.

### SUMMARY

Disclosed herein is a process for converting biomass, such as wastes containing moisture, to heat and/or power. In some embodiments, the process includes heating the biomass, such as a waste stream, under conditions for hydrothermal carbonization, such as to a temperature between 180° C. and 280° C., including about 250° C., under pressure and anaerobic conditions (e.g., in the presence of nitrogen) and then providing oxygen, such as in air, for a time between 5 minutes and 8 hours to the hot stream so that the waste undergoes aqueous oxidation, thereby producing a clean product stream and thermal energy. As the steps in the disclosed process are exothermic, energy, such as heat, is produced in addition to a clean product.

Several industries require heat for their operations. Simultaneously, the operations produce large volumes of waste. The disclosed process allows for conversion of these waste streams to heat or power. At the same time, a water byproduct is produced that can be easily upgraded for process or agricultural use. In some examples, the disclosed process is contemplated to be useful in a variety of industries including industrial, agricultural, municipal, and commercial sectors. For example, in some embodiments, it is utilized by dairies, swine producers, corn ethanol production, feedlots, waste haulers, landfill operators or other industries with wastewater processing needs. In one specific example, the disclosed process is utilized by a dairy. For example, dairies need heat for sterilization and wastewater facilities require heat for temperature control. At the same time, dairies spend a lot of effort and especially money on disposal of wet wastes. The disclosed process offers a technology to solve both problems simultaneously. The disclosed process allows for conversion of wet wastes without drying, an important cost savings compared to gasification or incineration. Compared to previously used anaerobic digestion, the disclosed process is very fast (such as 5 minutes in the first stage and 5 minutes in the second stage and no more than approximately 1 hour in the first stage and 1 hour in the second stage) and thus, has a small footprint. The process is scaleable and can be implemented with off-the-shelf equipment, such as pumps, pipes, valves, etc. The disclosed method can be used to process wastes, such as wet wastes, including manure, sludge, food wastes, algae, etc. from household to industry. It does not require oxygen during the reduction of the biomass to organic carbon which is commercially advantageous.

The foregoing and other features and advantages of the disclosure will become more apparent from the following detailed description and brief description of drawings.

### BRIEF DESCRIPTION OF DRAWINGS

FIG. 1 is a flow diagram illustrating a process of biomass conversion in accordance with an embodiments described herein; and

FIG. 2 is a graph and table illustrating total organic carbon following hydrothermal carbonization (HTC)-wet air oxidation (WAO) or wet air oxidation (WAO) followed by wet air oxidation (WAO).

### DETAILED DESCRIPTION OF SEVERAL EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Suitable methods and materials for the practice of the disclosed embodiments are described below. In addition, any appropriate method or technique well known to the ordinarily skilled artisan can be used in the performance of the disclosed embodiments.

All publications, patent applications, patents, and other references mentioned herein are incorporated by reference in their entirety. In case of conflict, the present specification, including explanations of terms, will control. In addition, the materials, methods, and examples are illustrative only and not intended to be limiting.

I. Introduction

Many industries require heat for their operations. At the same time, those industries produce large volumes of waste. Prior to the disclosed process, the following three processes were available to address this need: (1) gasification; (2) incineration; and (3) anaerobic digestion. Each of these processes is associated with multiple disadvantages. First, gasification is a technology that has been in development for many years, and faces numerous technical and cost challenges. Second, incineration while being a technology that has been available for many years is very expensive, and new installations are unlikely. For example, obtaining the permits required for a new installation is exceedingly complex and expensive. Third, while anaerobic digestion is being used on a routine basis for wastewater processing, it is disadvantageous for at least the following reasons: (1) after processing there is still a significant solid residue requiring disposal; (2) the efficiency of conversion to heat is low; (3) the process is very slow (20 to 60 hours) requiring a very large footprint; and (4) the process operations are biological and often highly complex. In contrast to the previously available technologies, the presently disclosed method converts wastes, such as wet biomass, into a clean product and energy, such as heat, and/or power in a fast (such as a total time of approximately 10 minutes and no more than 2 hours) and efficient (no drying required) manner.

The disclosed method is advantageous because it uses an environmentally-friendly solvent (e.g., water) to decompose and oxidize a variety of organics including food waste, waste oil, damp wood, vegetation and plastics. Moreover, the disclosed method is a highly controllable thermochemical process unlike biochemical processes (e.g., anaerobic digestion) that are susceptible to micro-organism vulnerability to pH, hormones, pharmaceutical products, aggressive chemicals, etc. Further, there is significantly lower emission than incineration, gasification, and pyrolysis, since the method operates at much lower temperatures with little to no risk of NOₓ emission. It meets the autothermic condition with auxiliary heat available for immediate use without the need for additional steps for combustion of reaction products (e.g., syngas). Additionally, it can recover and heat-sterilize recovered water from solid waste and wastewater/sewage streams, minimizing the possibility of pathogen contamination. It has the potential to provide 95-97% volume reduction in the waste. It does not require the presence of oxygen in the first phase (hydrothermal carbonization) which reduces costs and increases efficiency.

II. Methods and Systems for Conversion of Biomass

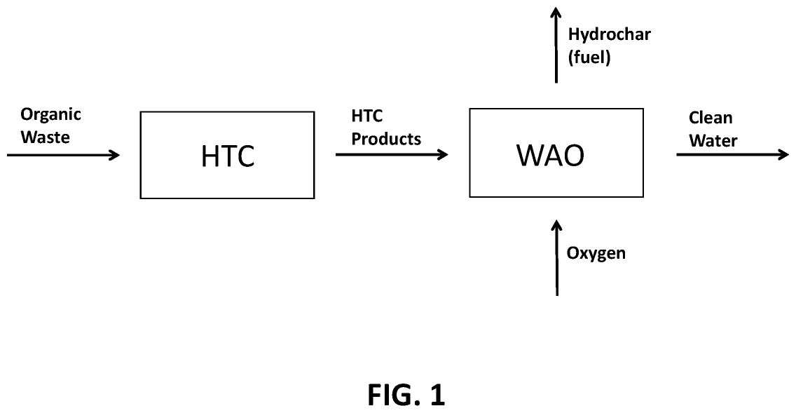

Disclosed herein are methods and systems for conversion of waste, such as biomass, into a clean product and energy, such as heat, and/or power. The disclosed method combines hydrothermal processing (HP), also known as hydrothermal carbonization (HTC), followed by wet air oxidation (WAO), adding sufficient oxygen to ensure rapid and complete destruction of organics. During the disclosed method, biomass components are oxidized to CO₂ and H₂O, while some fraction is left behind either in the solid or the liquid phase, depending on the reaction conditions of temperature, time, catalyst, oxygen content, etc. Given that both steps are exothermic, efficient recovery of the heat of reactions yields net heat generation. When the organic fraction is fully oxidized, 100% of the fuel value is converted to heat. FIG. 1 provides a diagram illustrating the disclosed process. As illustrated in FIG. 1, oxygen is only added to the wet air oxidation step. In fact, hydrothermal carbonization is performed in anaerobic conditions, such as in the presence of nitrogen.

Waste in this disclosure, includes any biomass solid or liquid, such as any wet biomass waste, such as organic matter including manure, sludge, food waste, algae, plant material such as trees, peat, plants, refuse, algae, grass, crops, crop residue, derivatives of raw biomass, and the like. Municipal and industrial wastewaters, some containing solids, some are so-called high-strength, are examples of waste in this disclosure. Waste can also include plastic and other compositions susceptible to destruction by the disclosed process. In some examples, the method is used to process a wet biomass mixture comprising a liquid to biomass ratio of between 50:1 and 4:1, including a liquid to biomass ratio of 25:1, 24:1, 23:1, 22:1, 21:1, 20:1, 19:1, 18:1, 17:1, 16:1, 15:1, 14:1, 13:1, 12:1, 11:1, 10:1. 9:1, 8:1, 7:1, 6:1, 5:1 or 4:1. In some examples, the ratio is at least 5:1 liquid to biomass. In some examples, the ratio is at least 10:1 liquid to biomass. In embodiments, the liquid is water. In some examples, the wet biomass is manure, sludge, food waste, plant material such as trees, peat, plants, refuse, algae, grass, crops, crop residue or a combination thereof. In some examples, the wet biomass mixture is dairy manure. In some examples, the wet biomass is industrial wastewater or sludge from food processing or biofuels production. In some examples, the wet biomass is sludge produced from converting corn to ethanol.

In some embodiments, the method includes anaerobic hydrothermal processing (HP), also known as hydrothermal carbonization, thermal hydrolysis, and wet torrefaction which is an effective thermochemical process, where wet waste is treated with hot compressed water (180-280° C.) for 5 minutes to 8 hours or longer, including between 5 minutes and 1 hour and, under circumstances of for less than 20 minutes, such as less than 10 minutes or 5 minutes at higher temperatures. For example, in some embodiments, the disclosed method converts waste, such as wet biomass, to energy and/or power within 10 to 20 minutes, such as between 3 and 10 minutes, including 3, 4, 5, 6, 7, 8, 9, 10, 11, 12, 13, 14, 15, 16, 17, 18, 19 or 20 minutes. In some embodiments, the hydrothermal carbonization reduces total organic carbon of the wet biomass by at least 20%, such as between 20% and 90%, 20% and 70% or 30% and 50%, including about 20%, about 25%, about 30%, about 35%, about 40%, about 45%, about 50%, about 55%, about 60%, about 65%, about 70%, about 75%, about 80%, or about 90%.

Subcritical water has maximum ionic product in temperature range of 200-280° C. In some examples, the waste, such as a waste stream, is rapidly heated to a reaction temperature of about 180° C. to 280° C., such as between 200° C. to 260° C., 220° C. to 250° C., including 180° C., 185° C., 190° C., 195° C., 200° C., 205° C., 210° C., 215° C., 220° C., 225° C., 230° C., 235° C., 240° C., 245° C., 250° C., 255° C., 260° C., 265° C., 270° C., 275° C. or 280° C. under high pressure, and held at that temperature for about 2-10 minutes, such as 2-5 minutes. At this temperature, the solvation properties of water become less polar, meaning that insoluble solids are likely to dissolve into the aqueous phase. Further, the ionic activity of water increases substantially, resulting in a highly reactive solvent with both acidic and basic properties. Biomass and other organic matter in the waste undergo hydrolysis during this step, producing sugars, furfurals, acids, and carbon dioxide. Depending on reaction time and temperature, additional chemical reactions can occur, including dehydration, decarboxylation, polymerization, etc.

Pressure during anaerobic hydrothermal processing is high enough to ensure that the water does not boil. In some examples, pressure remains relatively constant. For example, pressure is held at between about 10 bar and about 75 bar during operation, at about 27 bar to about 60 bar, about 50 bar to about 70 bar, about 40 bar to about 60 bar, about 47 bar to about 53 bar, about 49 bar to about 52 bar, about 35 bar to about 60 bar, and about 40 bar to about 65 bar, such as about 25 bar, 26 bar, 27 bar, 28 bar, 29 bar, 30 bar, 31 bar, 32 bar, 33 bar, 34 bar, 35 bar, 36 bar, 37 bar, 38 bar, 39 bar, 40 bar, 41 bar, 42 bar, 43 bar, 44 bar, 45 bar, 46 bar, 47 bar, 48 bar, 49 bar, 50 bar, 51 bar, 52 bar, 53 bar, 54 bar, 55 bar, 56 bar, 57 bar, 58 bar, 59 bar, 60 bar, 31 bar, 62 bar, 63 bar, 64 bar, 65 bar, 66 bar, 67 bar, 68 bar, 69 bar, 70 bar, 71 bar, 72 bar, 73 bar, 74 bar, and 75 bar. This first step/phase is performed under anaerobic conditions, such as in the presence of nitrogen.

The disclosed method further includes a second step which is also done in hydrothermal conditions, but with the addition of oxygen. Oxygen can be added as a pure gas, as air which contains 21% oxygen naturally, or as another mixture. By itself, this step is known as wet air oxidation which is similar to aqueous-phase combustion, with production of significant quantities of combustion products, for example, carbon dioxide and water. A byproduct of wet air oxidation is acetic acid, which is not easily oxidized under these conditions. In some examples, wet air oxidation is performed at temperatures similar to HP such as at about 180° C. to 280° C., such as between 200° C. to 260° C., 220° C. to 250° C., including 180° C., 185° C., 190° C., 195° C., 200° C., 205° C., 210° C., 215° C., 220° C., 225° C., 230° C., 235° C., 240° C., 245° C., 250° C., 255° C., 260° C., 265° C., 270° C., 275° C. or 280° C., allowing for ease of operation, under high pressure, and held at that temperature for about 2-10 minutes, such as 2-5 minutes, including 2, 3, 4, 5, 6, 7, 8, 9, or 10 minutes in the presence of oxygen. In some embodiments, pressure of wet air oxidation is higher than HP, due to the addition of oxygen.

In some embodiments, pressure in wet air oxidation is similar to that of HP or it is less than that in HP. Thus, in some embodiments, pressure remains relatively constant. For example, pressure is held at between about 10 bar and about 75 bar during operation, at about 15 bar to about 60 bar, about 50 bar to about 70 bar, about 40 bar to about 60 bar, about 47 bar to about 53 bar, about 49 bar to about 52 bar, about 35 bar to about 60 bar, and about 40 bar to about 65 bar, about 10 to about 15, about 10 to about 30, such as about 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 31 bar, 32 bar, 33 bar, 34 bar, 35 bar, 36 bar, 37 bar, 38 bar, 39 bar, 40 bar, 41 bar, 42 bar, 43 bar, 44 bar, 45 bar, 46 bar, 47 bar, 48 bar, 49 bar, 50 bar, 51 bar, 52 bar, 53 bar, 54 bar, 55 bar, 56 bar, 57 bar, 58 bar, 59 bar, 60 bar, 31 bar, 62 bar, 63 bar, 64 bar, 65 bar, 66 bar, 67 bar, 68 bar, 69 bar, 70 bar, 71 bar, 72 bar, 73 bar, 74 bar, and 75 bar.

Anaerobic hydrothermal processing is a useful pretreatment for wet air oxidation, since it dissolves insoluble matter, starts the oxidation process, and can significantly reduce the amount of oxygen required for complete destruction of the waste. Thus, the disclosed method combines anaerobic hydrothermal processing and wet air oxidation which allows the conversion of wet biomass to be cleaned and an energy and/or power source created simultaneously. The disclosed process is done without drying, does not require cooling in between the two processes and does not require oxygen in the hydrothermal carbonization step (e.g., it is under anaerobic conditions, such as in the presence of nitrogen).

A reactor system is utilized to perform the disclosed method. In some examples, a continuous reactor system such as that disclosed in International Application No. PCT/US2016/061367 which is hereby incorporated in its entirety is employed. For example, the method includes providing a waste mixture, such as a wet biomass mixture, to a feed chamber of a reactor system wherein the waste is prepared for processing; applying pressure to the system; providing the mixture to the reaction chamber; heating the wet mixture in the reaction chamber so that the wet biomass mixture is carbonized along the reaction chamber to produce gas, liquid and solid products; and subsequently providing oxygen to the reaction to destroy the solid products. Oxygen is added at the completion of the first stage, known here as anaerobic hydrothermal processing. Sufficient oxygen is added to allow for total oxidation of all organic components produced in the HP stage, including dissolved species and suspended solids. The temperature in the second stage might be the same as that in the anaerobic HP stage, or it might be more than that, or less than that.

In one specific example, the method is performed by performing each stage for 2-10 minutes, such as for 5 minutes. For example, waste, such as a wet biomass is added to a reactor, the contents is heated up to hydrothermal carbonization temperature and held for 5 minutes, and then pure oxygen at a specific sufficiently high partial pressure, such as 10 bars or more, is added into reactor for 5 minutes. Those experienced in the arts will recognize the necessity for energy recovery. Thus, products from wet air oxidation can be cooled, if desired, by preheating the HP reactants in a heat exchanger. Alternatively, the hot products can be used to produce electrical power, for example with an organic rankine cycle, or to produce steam.

The following non-limiting example is provided to illustrate certain particular features and/or embodiments. This example should not be construed to limit the disclosure to the particular features or embodiments described.

### EXAMPLES

### Example 1

This example provides an exemplary process for converting corn ethanol wastes into heat and/or steam and clean water.

The corn ethanol industry produces significant aqueous waste streams containing large amounts of dissolved organic matter. The waste streams require substantial cleanup before being dumped to surface waters, or even to municipal wastewater treatment operations. At the same time, the industry consumes massive amounts of natural gas, used primarily to produce steam, which is used throughout the plant for various purposes. To better promote corn ethanol as a “green” biofuels with a carbon footprint below that of petroleum, it is desirable to identify alternative, renewable sources of heat. Thus, there is an opportunity to convert the organic matter in the waste streams to heat by chemical oxidation, thereby solving both a waste disposal problem and a heat-supply problem. The method described herein provides a cost-effective process for doing so which both reduces process costs and increases sustainability of corn ethanol by converting these waste streams to heat. The process is done in hot, compressed water, thereby treating the waste in its available form, without need for pretreatment of any sort.

Disclosed is a method which integrates anaerobic hydrothermal processing with wet air oxidation. A representative corn ethanol plant produces three significant aqueous waste streams: thin stillage (TS, backset), process condensate (PC), and syrup. Each stream contains organic matter represented here as COD, i.e., the amount of oxygen required for complete oxidation of organic matter. Net heat was calculated from careful analysis of a series of experiments, including calorimetry of freeze-dried solids derived from waste streams and the generated product streams.

The volume of PC was quite large; however, due to the low COD, the maximum heat available by oxidation was small. On the other hand, the syrup was produced at a small volume, and it was highly laden with COD, so its' potential for producing heat is quite significant. It is contemplated that in some industrial applications, the multiple streams can be blended.

The heat listed is the amount that would be released by aqueous-phase oxidation. Steam could be generated by transferring heat from the reactor to treated water, e.g., in a shell-and-tube configuration. Alternatively, the hot water product produced can be used directly for heat in process applications, e.g., distillation.

As discussed below, the product stream is clear, and contains primarily small carboxylic acids, and is mildly acidic. The stream might be further treated by rapid single-stage anaerobic digestion, or sent to sewage.

Two waste streams were evaluated. The pH before and after treatment for thin stillage and for syrup was evaluated. Process condensate was not tested, due to the relatively low amount of COD present. The disclosed process decreased COD significantly.

### Example 2

This example demonstrates the effectiveness of hydrothermal carbonization as a pretreatment for the neutralization of organic sludge and toxic wastewater by wet air oxidation (WAO). The coupled hydrothermal carbonization-wet air oxidation process was studied at 230° C., and a combined reaction time of 30 minutes. Results are quantified in terms of rate of depletion of total organic carbon (TOC). The wet air oxidation process following hydrothermal carbonization treatment showed a higher total organic carbon depletion rate than the wet air oxidation alone, indicating that the efficiency of wet air oxidation is increased by pretreatment by anaerobic hydrothermal carbonization.

Hydrothermal carbonization and wet air oxidation are both processes that have been studied, yet the coupling of the processes for use in treatment of wastewater streams remains unexplored. Hydrothermal carbonization involves rapidly heating liquid slurries to temperatures ranging from 180 t to 300° C. under anaerobic conditions while maintaining pressures high enough to ensure that the liquid does not vaporize. This process has been proven to produce neutral, energy dense solids known as hydrochar along with a liquid phase consisting of a wide range of organic molecules. Similarly, wet air oxidation is a process where liquid waste streams are heated and pressurized much like hydrothermal carbonization with the addition of oxygen. In this process, aqueous phase combustion occurs neutralizing the majority of organics in the solution. The products of wet air oxidation are mainly carbon dioxide, water, and some organic acids that are not easily neutralized such as acetic acid. Wet air oxidation has been commercialized and proven to be an effective treatment of wastewater sludge, yet requires the use of catalysts or exhibits low chemical oxygen demand depletion when used alone. Due to the benefits of each process and congruence in reaction conditions, the coupling of the processes lead to increased efficiency in wastewater treatment without the need for costly catalysts or long reaction times. Hydrothermal carbonization neutralizes solid organics while transferring chemical oxygen demand (COD) into the liquid phase and also begins the primary reactions that take place in wet air oxidation. Wet air oxidation then oxidizes the organic liquids, depleting the COD of the liquid by oxidizing the organic molecules and yielding treated water.

Materials and Methods

Reactor Configuration and Set Up.

All experiments were performed in a 2 L parr reactor equipped with intermittent process liquid sampling and biomass injection capabilities. The reactor temperature was controlled by a Parr temperature controller and held at 230° C. for the duration of the experiments.

Synthetic Wastewater Preparation.

The synthetic wastewater used in the experiments consisted of a solution of the following composition by mass: 98% water, 1% glucose, 1% yeast (dried). The total organic carbon of the standard solution was measured prior to experimentation and the solution was made fresh immediately before each experiment to ensure consistency.

Coupled Studies.

The coupled hydrothermal carbonization (HTC)-wet air oxidation (WAO) experiments were performed at 230° C., with both hydrothermal carbonization and wet air oxidation having a duration of 15 minutes. The wastewater constituents were injected into the reactor once the reactor had reached steady state at 230° C. in order to minimize error due to the heating period of the reactor. The first sample was withdrawn after 15 minutes of hydrothermal carbonization. Directly after the sample was withdrawn, the reactor was charged with 10 bar of oxygen and wet air oxidation was allowed to take place for 15 minutes. After 15 minutes a second sample was withdrawn. This experiment was performed 3 times.

WAO Only Studies.

The wet air oxidation experiment was used as a control to compare to the hydrothermal carbonization-wet air oxidation process. The wet air oxidation experiment was carried out in the same fashion as the coupled experiments, except with the introduction of oxygen at the beginning of the experiment instead of at the 15 minute mark. The wastewater constituents were injected into the reactor upon achievement of the 230° C., and a sample was withdrawn at both 15 and 30 minutes. This experiment was performed in triplicates.

Analysis and Discussion

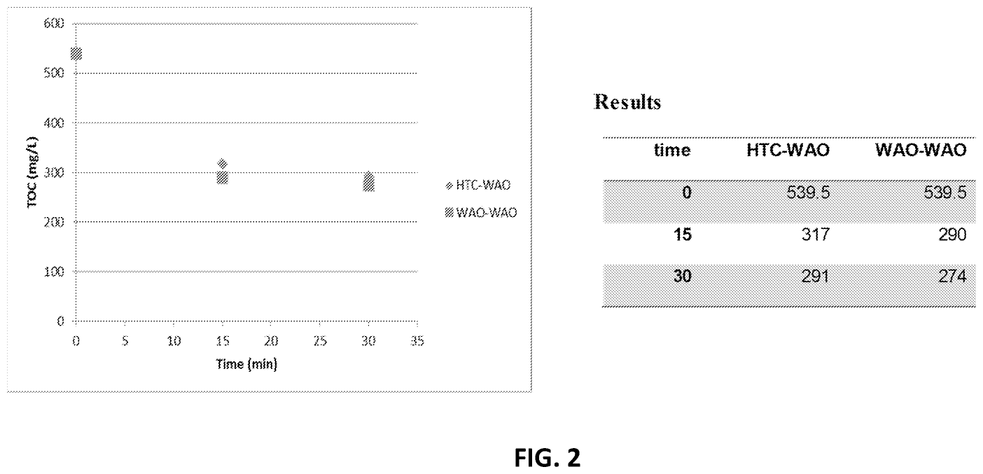

The total organic carbon (TOC) of all solutions was measured using standard spectrophotometric methods. The total organic carbon of the untreated synthetic wastewater was 540 mg/L. FIG. 2 shows total organic carbon in the untreated and treated wastewater. The column labeled “HTC-WAO” shows total organic carbon was reduced to 317 mg/L after 15 minutes by hydrothermal treatment, while the column labeled “WAO-WAO” shows that with 10 bars of oxygen, the total organic carbon was reduced to 290 mg/L. This is a remarkable result, since it shows that in the absence of oxygen, hydrothermal conditions are reducing significantly the organic carbon. It is believed that this is done by oxidation to produce carbon dioxide. The results for each step and the overall processes are provided in Tables 1A-1C, where “total Process” represents the entire 30 minutes of the given process, “pre-Treatment Step” represents the first 15 minutes of the process, and “Treatment Step” represents the final 30 minutes of the process.

TABLE 1A
Total Process

| Step | Rate (mg/(L*min) | Uncertainity (mg/(L*min) |
|---|---|---|
| HTC-WAO | 8.29 | 0.36 |
| WAO-WAO | 8.84 | 0.43 |

TABLE 1B
Pre-Treatment Step

| Step | Rate (mg/(L*min) | Uncertainity (mg/(L*min) |
|---|---|---|
| HTC-WAO | 7.41 | 0.55 |
| WAO-WAO | 8.32 | 0.44 |

TABLE 1C
Treatment Step

| Step | Rate (mg/(L*min) | Uncertainity (mg/(L*min) |
|---|---|---|
| HTC-WAO | 0.88 | 0.24 |
| WAO-WAO | 0.53 | 0.02 |

Hydrothermal carbonization neutralizes solid organics while transferring chemical oxygen demand into the liquid phase and also begins the primary reactions that take place in wet air oxidation. Wet air oxidation then oxidizes the organic liquids, depleting the total organic carbon of the liquid by oxidizing the organic molecules and yielding treated water and solid carbon. Using hydrothermal carbonization as a pretreatment for wet air oxidation effectively breaks down complex organic molecules and transfers them into liquids, which are then rapidly oxidized by wet air oxidation. In an industrial setting, hydrothermal carbonization can be used to produce an energy dense solid, as well as create a solution ready for rapid treatment by wet air oxidation. In the present study, the 30 minutes wet air oxidation process showed a slightly higher total organic carbon depletion than the coupled processes. Hydrothermal carbonization has been proven to increase the efficiency of wet air oxidation when used as a pretreatment step.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims.

1. A method, comprising:
providing a waste mixture to a reaction chamber;
heating the waste mixture while under pressure and anaerobic conditions to a temperature sufficient for hydrothermal carbonization;
providing oxygen to the reaction chamber for a period of time sufficient for the waste mixture to undergo aqueous oxidation, thereby producing a clean product and energy and/or power, wherein the waste mixture is a wet biomass mixture and the wet biomass mixture is a wet biomass mixture of a liquid to biomass ratio of 9:1.

2. (canceled)

3. (canceled)

4. The method of claim 1, wherein the wet biomass mixture comprises water.

5. The method of claim 1, wherein the waste mixture comprises manure, sludge, food waste, plant material such as trees, peat, plants, refuse, algae, grass, crops, crop residue, industrial waste, food waste, or a combination thereof.

6. (canceled)

7. The method of claim 5, wherein heating the waste mixture to a temperature sufficient for hydrothermal comprises heating the reaction chamber to between 180° C. and 280° C. and allowing the reaction to occur for between 2 and 20 minutes.

8. The method of claim 5, wherein heating the waste mixture to a temperature sufficient for hydrothermal comprises heating the reaction chamber to between 230° C. and 250° C. and allowing the reaction to occur for between 2 and 20 minutes.

9. The method of claim 5, wherein providing oxygen to the reaction chamber for a period of time sufficient for the waste mixture to undergo aqueous oxidation comprises maintaining the temperature of the reaction chamber as that in which the heating occurred while providing pure oxygen and allowing the reaction in the presence of oxygen to occur for between 2 and 20 minutes.

10. The method of claim 5, wherein pressure is 50 bar during hydrothermal carbonization and 10 bar during aqueous oxidation.

11. The method of claim 5, wherein heating the waste mixture while under pressure and anaerobic conditions to a temperature sufficient for hydrothermal carbonization comprises heating in the presence of nitrogen.

12. The method of claim 1, wherein the clean product and energy and/or power is formed without requiring a drying process.

13. The method of claim 1, wherein hydrothermal carbonization reduces the total organic carbon of the waste mixture by at least 30%.

14. The method of claim 13, wherein hydrothermal carbonization reduces the total organic carbon of the waste mixture by between 40% and 60%.

15. A method of pretreating a waste mixture for wet air oxidation, comprising:
providing a waste mixture to a reaction chamber; and
heating the waste mixture under anaerobic conditions to between 180° C. and 280° C. and allowing the reaction to occur for between 2 and 30 minutes thereby allowing hydrothermal carbonization, wherein hydrothermal carbonization reduces the total organic carbon of the waste mixture by at least 30% and prepares the waste mixture for wet air oxidation wherein the waste mixture is a wet biomass mixture and the wet biomass mixture is a wet biomass mixture of a liquid to biomass ratio of 9:1.

16. The method of claim 15, wherein hydrothermal carbonization reduces the total organic carbon of the waste mixture by between 40% and 60%.

17. (canceled)

18. The method of claim 16, wherein the wet biomass mixture comprises water.

19. The method of claim 15, wherein the waste mixture comprises manure, sludge, food waste, plant material such as trees, peat, plants, refuse, algae, grass, crops, crop residue, industrial waste, food waste, or a combination thereof.

20. (canceled)

21. The method of claim 15, wherein heating the waste mixture to a temperature sufficient for hydrothermal comprises heating the reaction chamber to between 230° C. and 250° C. and allowing the reaction to occur for between 2 and 20 minutes.

22. The method of claim 15, further comprising providing oxygen to the reaction chamber for a period of time sufficient for the waste mixture to undergo aqueous oxidation, thereby producing a clean product and energy and/or power.
